(19) United States
(12) Patent Application Publication
(10) Pub. No.: US 2024/0343025 A1
(43) Pub. Date: Oct. 17, 2024

(54) LAMINATION FILM HAVING FOLDING DURABILITY, AND DISPLAY DEVICE COMPRISING SAME

(71) Applicants: SK MICROWORKS SOLUTIONS CO., LTD., Cheonan-si, Chungcheongnam-do (KR); SK MICROWORKS CO., LTD., Gyeonggi-do (KR)

(72) Inventors: Jun-Ki PARK, Chungcheongnam-do (KR); Seok-Jong WOO, Chungcheongnam-do (KR); Hyung-Woo CHO, Chungcheongnam-do (KR); Kweon Hyung HAN, Chungcheongnam-do (KR); Kwangho JANG, Chungcheongnam-do (KR)

(73) Assignee: SK MICROWORKS CO., LTD., Gyeonggi-do (KR)

(21) Appl. No.: 18/292,425

(22) PCT Filed: Jun. 27, 2022
(86) PCT No.: PCT/KR2022/009140

§ 371 Date: Jan. 26, 2024

(30) Foreign Application Priority Data
Jul. 30, 2021 (KR) 10-2021-0101029

(51) Int. Cl. B32B 27/08; B32B 27/28; B32B 27/34; B32B 37/24

(52) U.S. Cl. CPC B32B 27/08; B32B 27/281; B32B 27/285; B32B 27/34; B32B 37/24; B32B 2037/243; B32B 2250/02; B32B 2250/24; B32B 2255/10; B32B 2255/26; B32B 2307/51; B32B 2307/7375; B32B 2307/748; B32B 2333/08; B32B 2367/00; B32B 2371/00; B32B 2377/00; B32B 2457/20

(57) ABSTRACT

A lamination film according to one implemented embodiment comprises: a base film; an elastic layer comprising polyether-block-amide; and a primer layer interposed between the base film and the elastic layer, and thus not only has flexibility but also has adhesiveness between heterogeneous films, thereby exhibiting folding durability

### TECHNICAL FIELD

Embodiments relate to a laminate film with folding durability and to a display device comprising the same.

### BACKGROUND ART

Display technologies continue to develop driven by the demand in tandem with the development in IT devices. Technologies on curved displays and bent displays have already been commercialized. In recent years, flexible display devices that can be flexibly bent or folded in response to an external force are preferred in the field of mobile devices that require large screens and portability at the same time. In particular, a foldable display device has the great advantages that it is folded to a smaller size to enhance its portability when not in use, and it is unfolded to form a larger screen when in use.

In such a flexible display, its cover window is required to have flexible characteristics. In particular, in a film applied to a foldable display device, a tensile load continues to be applied to the film in the folded state. If it does not secure sufficient flexibility and interlayer adhesion, cracks or interlayer delamination may take place.

Korean Laid-open Patent Publication No. 2017-0109746 discloses a technique of preparing a protective film in which a soft layer using a urethane acrylate resin and silicone rubber is formed on one side of a base layer, which is applied to the cover window of a flexible display. However, since this protective film is prepared in a thin form, it has limitations in performance, and it also has the problem of different feelings from the cover window.

### PRIOR ART DOCUMENT

(Patent Document 1) Korean Laid-open Patent Publication No. 2017-0109746

### DISCLOSURE OF INVENTION

### Technical Problem

Referring to FIG. 1a, in an in-folding type (1a), a load is applied to the point (p1) that is folded inward. Referring to FIG. 1b, in an out-folding type (1b), a load is applied to the point (p2) that is folded outward. If the cover window (10) does not secure sufficient flexibility and interlayer adhesion, cracks or interlayer delamination may take place due to the load applied during folding, thereby deteriorating characteristics.

As a result of research conducted by the present inventors, it has been discovered that, when an elastic layer comprising a polyether-block-amide is laminated with a base film through a primer layer, not only can flexibility be secured, but adhesion between different types of films can also be secured, thereby achieving folding durability.

Accordingly, the embodiments to be described below aim to provide a laminate film with excellent folding durability by securing interlayer adhesion and a display device comprising the same.

### Solution to Problem

According to an embodiment, there is provided a laminate film that comprises a base film; an elastic layer comprising a polyether-block-amide; and a primer layer interposed between the base film and the elastic layer.

According to another embodiment, there is provided a process for preparing a laminate film that comprises preparing a primer composition; applying the primer composition onto a base film and curing it to form a primer layer; and laminating the base film and an elastic layer through the primer layer to prepare a laminate film, wherein the elastic layer comprises a polyether-block-amide.

According to another embodiment, there is provided a display device that comprises a display panel; and a laminate film disposed on the front side of the display panel, wherein the laminate film comprises a base film; an elastic layer comprising a polyether-block-amide; and a primer layer interposed between the base film and the elastic layer.

### Advantageous Effects of Invention

In the laminate film according to an embodiment, an elastic layer comprising a polyether-block-amide is laminated with a base film through a primer layer; thus, not only can flexibility be secured, but adhesion between different types of films can also be secured, thereby achieving folding durability.

Accordingly, when the laminate film according to the embodiment is applied to the cover of a flexible display device, for example, an out-folding or in-folding type device, in which the display is exposed to the outside, it can have flexible characteristics and maintain excellent performance even after repeated folding.

### BRIEF DESCRIPTION OF DRAWINGS

FIGS. 1a and 1b each show in-folding or out-folding type flexible display devices.

FIG. 2 shows an exploded perspective view of a display device according to an embodiment.

FIG. 3 shows a cross-sectional view of a laminate film according to an embodiment (A-A′ in FIG. 2).

FIG. 4 shows an example of a peel test method for a laminate film sample.

FIG. 5 shows an example of a folding test method for a laminate film sample.

### DESCRIPTION OF THE NUMERALS

| | |
|---|---|
| 1: display device | |
| 1a: in-folding type flexible display device | |
| 1b: out-folding type flexible display device | |
| 2: peel test device | 3: folding tester |
| 10: laminate film (cover window) | 10a: sample |
| 20: display panel | 30: board |
| 40: frame | 100: base film |
| 200: primer layer | 300: elastic layer |
| N: load | p1, p2: folding points |
| a: peeling angle | |

### BEST MODE FOR CARRYING OUT THE INVENTION

Hereinafter, various embodiments and examples will be described in detail by referring to the drawings.

In the description of the following embodiments, if it is determined that a detailed description of a relevant known constitution or function may obscure the subject matter, the detailed description thereof will be omitted. In addition, the sizes of individual elements in the drawings may be exaggeratedly depicted or omitted for the sake of description, and they may differ from the actual sizes.

In the present specification, when one component is described to be formed on/under another component or connected or coupled to each other, it covers the cases where these components are directly or indirectly formed, connected, or coupled through another component. In addition, it should be understood that the reference for the on/under position of each component may vary depending on the direction in which the object is observed.

In this specification, terms referring to the respective components are used to distinguish them from each other and are not intended to limit the scope of the embodiment. In addition, in the present specification, a singular expression is interpreted to cover a plural number as well unless otherwise specified in the context.

In the present specification, the term “comprising” is intended to specify a particular characteristic, region, step, process, element, and/or component. It does not exclude the presence or addition of any other characteristic, region, step, process, element and/or component, unless specifically stated to the contrary.

In the present specification, the terms first, second, and the like are used to describe various components. But the components should not be limited by the terms. The terms are used for the purpose of distinguishing one element from another.

The molecular weight of a compound or polymer described in the present specification, for example, a number average molecular weight or a weight average molecular weight, is a relative mass based on carbon-12 as is well known. Although its unit is not described, it may be understood as a molar mass (g/mole) of the same numerical value, if necessary.

The embodiments to be described below provide a laminate film with excellent folding durability by securing interlayer adhesion and a display device comprising the same.

The display device according to an embodiment may be flexible. For example, the display device according to an embodiment may be a flexible display device. Specifically, it may be a foldable display device. More specifically, the foldable display device may be an in-folding type or an out-folding type depending on the folding direction.

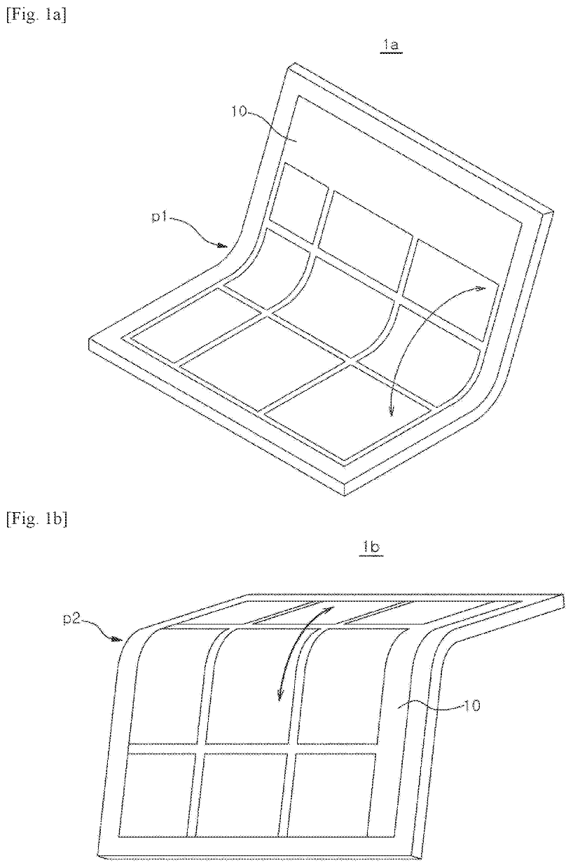

FIGS. 1a and 1b each show in-folding and out-folding type flexible display devices. Referring to FIG. 1a, the display device may be an in-folding type flexible display device (1a) in which the screen is located inside the folding direction. Alternatively, referring to FIG. 1b, the display device may be an out-folding type flexible display device (1b) in which the screen is located outside the folding direction.

In such flexible displays, the cover window is required to have flexible characteristics. In an in-folding type display device where the display is located inside, and in an out-folding type display device where the display is exposed to the outside, excellent performance is required to be maintained even after repeated folding in addition to flexibility.

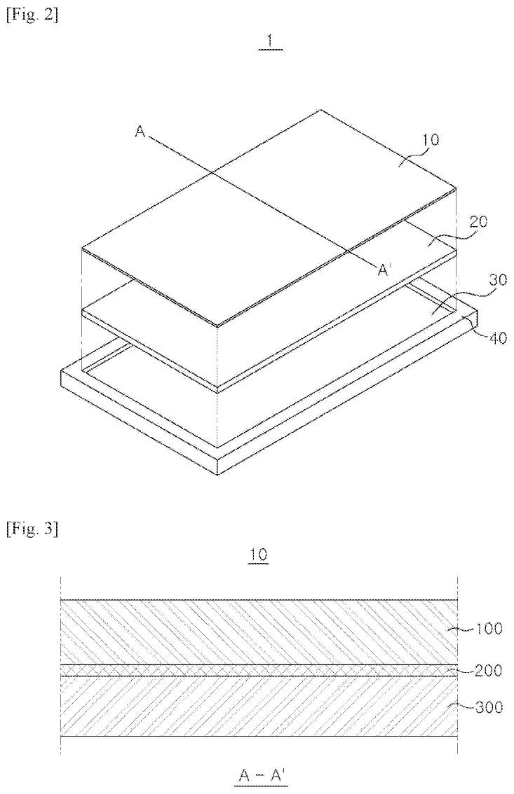

FIG. 2 shows an exploded perspective view of a display device according to an embodiment. Referring to FIG. 2, the display device (1) comprises a cover window (10), a display panel (20), a board (30), and a frame (40) protecting them. In addition, an adhesive layer may be interposed between the cover window (10) and the display panel (20). For example, the adhesive layer may comprise an optically transparent adhesive.

The display panel (20) may be a liquid crystal display (LCD) panel. Alternatively, the display panel (20) may be an organic light emitting display (OLED) panel. The organic light emitting display device may comprise a front polarizing plate and an organic light emitting display panel. The front polarizing plate may be disposed on the front side of the organic light emitting display panel. In more detail, the front polarizing plate may be bonded to the side of the organic light emitting display panel where an image is displayed. The organic light emitting display panel displays an image by self-emission of a pixel unit. The organic light emitting display panel comprises an organic light emitting substrate and a driving substrate. The organic light emitting substrate comprises a plurality of organic light emitting units that correspond to respective pixels. The organic light emitting units each comprise a cathode, an electron transport layer, a light emitting layer, a hole transport layer, and an anode. The driving substrate is operatively coupled to the organic light emitting substrate. That is, the driving substrate may be coupled to the organic light emitting substrate so as to apply a driving signal such as a driving current. More specifically, the driving substrate may drive the organic light emitting substrate by applying a current to each of the organic light emitting units.

The laminate film according to an embodiment is applied to the display device (1) as a cover window (10).

That is, the display device according to an embodiment comprises a display panel; and a laminate film disposed on the front side of the display panel.

The laminate film according to an embodiment comprises a base film; an elastic layer comprising a polyether-block-amide; and a primer layer interposed between the base film and the elastic layer.

When the laminate film according to an embodiment is cut to a size of 5 cm in length and 1 cm in width and subjected to a 180° peel test at a speed of 300 mm/minute at room temperature, the adhesive force between the base film and the elastic layer is 15 gf/inch or more.

FIG. 3 shows a cross-sectional view of a laminate film (cover window) according to an embodiment (A-A′ in FIG. 2).

Referring to FIG. 3, the laminate film (10) according to an embodiment comprises a base film (100); an elastic layer (300) comprising a polyether-block-amide; and a primer layer (200) interposed between the base film (100) and the elastic layer (300).

In the laminate film according to an embodiment, an elastic layer comprising a polyether-block-amide is laminated with a base film through a primer layer; thus, not only can flexibility be secured, but adhesion between different types of films can also be secured, thereby achieving folding durability.

### Process for Preparing a Laminate Film

The laminate film is prepared by a process, which comprises (1) preparing a primer composition; (2) applying the primer composition onto a base film and curing it to form a primer layer; and (3) laminating the base film and an elastic layer through the primer layer to prepare a laminate film. When the laminate film is cut to a size of 5 cm in length and 1 cm in width and subjected to a 180° peel test at a speed of 300 mm/minute at room temperature, the adhesive force between the base film and the elastic layer is 15 gf/inch or more.

Hereinafter, each step will be described in detail.

In step (1), a primer composition is prepared.

The primer composition comprises a binder resin. For example, it may comprise a curable resin, specifically, a UV curable resin.

As an example, the primer composition may comprise a polyester acrylate. A polyester acrylate resin has low viscosity, good workability, and good compatibility with various oligomers or polymers.

The polyester acrylate may have a structure in which an acrylate group (or acryloyl group) is substituted in the polyester main chain.

The polyester acrylate may have 1 to 6 acrylate groups introduced as needed.

The polyester acrylate may be obtained by first preparing a polyester and then reacting both ends of the polyester with acrylic acid. The polyester may be prepared by polymerization of a dicarboxylic acid and a diol. Examples of the dicarboxylic acid include terephthalic acid, isophthalic acid, orthophthalic acid, 2,5-naphthalene dicarboxylic acid, 2,6-naphthalene dicarboxylic acid, 1,4-naphthalene dicarboxylic acid, 1,5-naphthalene dicarboxylic acid, diphenyl dicarboxylic acid, diphenoxyethane dicarboxylic acid, diphenyl sulfone dicarboxylic acid, anthracene dicarboxylic acid, 1,3-cyclopentane dicarboxylic acid, 1,3-cyclohexane dicarboxylic acid, 1,4-cyclohexane dicarboxylic acid, hexahydroterephthalic acid, hexahydroisophthalic acid, malonic acid, dimethyl malonic acid, succinic acid, 3,3-diethyl succinic acid, glutaric acid, 2,2-dimethylglutaric acid, adipic acid, 2-methyladipic acid, trimethyladipic acid, pimelic acid, azelaic acid, sebacic acid, suberic acid, dodecadicarboxylic acid, and the like. In addition, examples of the diol include ethylene glycol, propylene glycol, hexamethylene glycol, neopentyl glycol, 1,2-cyclohexanedimethanol, 1,4-cyclohexanedimethanol, decamethylene glycol, 1,3-propanediol, 1,4-butanediol, 1,5-pentanediol, 1,6-hexanediol, 2,2-bis(4-hydroxyphenyl) propane, bis(4-hydroxyphenyl) sulfone, and the like.

The reaction between a polyester and acrylic acid may be carried out in the presence of an acid catalyst.

The polyester acrylate may be in the form of an oligomer or a polymer. For example, the polyester acrylate may have a weight average molecular weight (Mw) of 1,000 or more, 2,000 or more, 2,500 or more, 3,000 or more, 3,500 or more, or 3,800 or more, and may be 50,000 or less, 30,000 or less, 20,000 or less, 10,000 or less, 7,000 or less, 5,000 or less, 4,500 or less, or 4,000 or less. As a specific example, the weight average molecular weight of the polyester acrylate may be 1,000 to 7,000.

As another example, the primer composition may comprise an acrylamide-based compound. As the primer composition comprises an acrylamide-based compound, not only the adhesion of the primer layer to the base film but also the adhesion thereof to the elastic layer can be enhanced.

As another example, the acrylamide-based compound may be represented by the following Formula I.

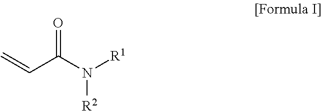

Here, R¹ and R² may each independently be hydrogen, a substituted or unsubstituted monovalent C₆-C₃₀ aliphatic cyclic group, a substituted or unsubstituted monovalent C₄-C₃₀ heteroaliphatic cyclic group, a substituted or unsubstituted monovalent C₆-C₃₀ aromatic cyclic group, a substituted or unsubstituted monovalent C₄-C₃₀ heteroaromatic cyclic group, a substituted or unsubstituted C₁-C₃₀ alkyl group, a substituted or unsubstituted C₂-C₃₀ alkenyl group, or a substituted or unsubstituted C₂-C₃₀ alkynyl group.

As a specific example, the acrylamide-based compound may be dimethylacrylamide.

As another example, the primer composition may comprise a polyester acrylate and an acrylamide-based compound.

As the weight ratio between the polyester acrylate and the acrylamide-based compound in the primer composition is adjusted to a certain range, interlayer adhesion can be further enhanced.

For example, the primer composition may comprise the acrylamide-based compound in an amount of 1 part by weight or more, 5 parts by weight or more, 10 parts by weight or more, 15 parts by weight or more, or 20 parts by weight or more, relative to 100 parts by weight of the polyester acrylate. In addition, the primer composition may comprise the acrylamide-based compound in an amount of 60 parts by weight or less, 50 parts by weight or less, 40 parts by weight or less, 30 parts by weight or less, or 25 parts by weight or less, relative to 100 parts by weight of the polyester acrylate.

Specifically, the primer composition may comprise the acrylamide-based compound in an amount of 5 parts by weight to 40 parts by weight, relative to 100 parts by weight of the polyester acrylate.

As another example, the primer composition may further comprise other acrylic resins.

The acrylic resin is an oligomer or a polymer having a repeat unit derived from a (meth)acrylic acid-based compound. It may be formed by polymerizing the (meth)acrylic acid-based compound. The (meth)acrylic acid-based compound may comprise (meth)acrylic acid and its derivatives. The derivative of (meth)acrylic acid may comprise, for example, a (meth)acrylic acid ester-based compound. As used herein, “(meth)acrylic acid” covers acrylic acid and methacrylic acid.

For example, the (meth)acrylic acid-based compound may comprise an ester compound in which (meth)acrylic acid is substituted with an alkyl group having 1 to 12 carbon atoms. For example, the (meth)acrylic acid ester compound may comprise a (meth)acrylic acid ester substituted with an alkyl group having 1 to 12 carbon atoms such as a methyl group, an ethyl group, a propyl group, a butyl group, a pentyl group, a hexyl group, a heptyl group, and an octyl group. Preferably, the alkyl group substituted in the ester compound may have 1 to 8 carbon atoms.

As a specific example, the (meth)acrylic acid-based compound may comprise ethyl acrylate, n-butyl acrylate, 2-ethylhexyl acrylate, (meth)acrylic acid, methyl (meth)acrylate, ethyl methacrylate, n-propyl (meth)acrylate, isopropyl (meth)acrylate, n-butyl (meth)acrylate, isobutyl (meth)acrylate, t-butyl (meth)acrylate, n-pentyl (meth)acrylate, n-hexyl (meth)acrylate, n-heptyl (meth)acrylate, n-octyl (meth)acrylate, 2-ethylhexyl (meth)acrylate, nonyl (meth)acrylate, decyl (meth)acrylate, dodecyl (meth)acrylate, tridecyl (meth)acrylate, cetyl (meth)acrylate, stearyl (meth)acrylate, behenyl (meth)acrylate, cyclohexyl (meth)acrylate, 4-tert-butylcyclohexyl (meth)acrylate, isobornyl (meth)acrylate, dicyclofentanyl (meth)acrylate, benzyl (meth)acrylate, N,N-dimethylaminoethyl (meth)acrylate, glycidyl (meth)acrylate, 2-hydroxyethyl (meth)acrylate, 3-hydroxypropyl (meth)acrylate, 4-hydroxy-n-butyl (meth)acrylate, 2-hydroxypropyl (meth)acrylate, 2-hydroxy-n-butyl (meth)acrylate, 3-hydroxy-n-butyl (meth)acrylate, 1,4-cyclohexanedimethanol mono(meth)acrylate, glycerin mono(meth)acrylate, polyethylene glycol mono(meth)acrylate, polypropylene glycol mono(meth)acrylate, 2-hydroxy-3-phenoxypropyl (meth)acrylate, 2-(meth)acryloyloxyethyl-2-hydroxyethyl phthalate, or lactone-modified (meth)acrylate with a hydroxyl group at the terminal. They may be used alone or in combination of two or more.

The primer composition may further comprise a photoinitiator.

Examples of the photoinitiator include 1-hydroxy-cyclohexyl-phenyl ketone, 2-hydroxy-2-methyl-1-phenyl-1-propanone, 2-hydroxy-1-[4-(2-hydroxyethoxy)phenyl]-2-methyl-1-propanone, methylbenzoylformate, α,α-dimethoxy-α-phenylacetophenone, 2-benzoyl-2-(dimethylamino)-1-[4-(4-morpholinyl)phenyl]-1-butanone, 2-methyl-1-[4-(methylthio)phenyl]-2-(4-morpholinyl)-1-propanone diphenyl(2,4,6-trimethylbenzoyl)-phosphine oxide, and bis(2,4,6-trimethylbenzoyl)-phenylphosphine oxide, but it is not limited thereto. In addition, commercially available products include Irgacure 184, Irgacure 500, Irgacure 651, Irgacure 369, Irgacure 907, Darocur 1173, Darocur MBF, Irgacure 819, Darocur TPO, Irgacure 907, and Esacure KIP 100F. The photoinitiator may be used alone or in combination of two or more different types.

The photoinitiator may be employed in the primer composition in an amount of 1 part by weight to 10 parts by weight or 3 parts by weight to 7 parts by weight, relative to 100 parts by weight of the total weight of the binder resin (for example, the polyester acrylate and acrylamide-based compound).

In step (2), the primer composition is applied onto a base film and cured to form a primer layer.

The primer layer may be formed by applying the primer composition onto a base film and drying and curing it.

The primer composition may comprise the binder resin and photoinitiator described above, other additives, and/or solvents.

Examples of the solvent include alcohol-based solvents such as methanol, ethanol, isopropyl alcohol, and butanol; alkoxy alcohol-based solvents such as 2-methoxyethanol, 2-ethoxyethanol, and 1-methoxy-2-propanol; ketone-based solvents such as acetone, methyl ethyl ketone, methyl isobutyl ketone, methyl propyl ketone, and cyclohexanone; ether-based solvents such as propylene glycol monopropyl ether, propylene glycol monomethyl ether, ethylene glycol monoethyl ether, ethylene glycol monopropyl ether, ethylene glycol monobutyl ether, diethylene glycol monomethyl ether, diethyl glycol monoethyl ether, diethylene glycol monopropyl ether, diethylene glycol monobutyl ether, and diethylene glycol-2-ethylhexyl ether; and aromatic solvents such as benzene, toluene, and xylene, which may be used alone or in combination thereof.

The content of the solvent is not particularly limited since it may be variously adjusted within a range that does not deteriorate the physical properties of the coating composition. For example, the solvent may be employed such that the solids content in the primer composition is 1% by weight to 50% by weight, specifically, 1% by weight to 30% by weight, more specifically, 1% by weight to 10% by weight. Within the above range, the primer composition may have appropriate flowability and coatability.

The primer composition may be applied through bar coating, knife coating, roll coating, blade coating, die coating, micro gravure coating, comma coating, slot die coating, lip coating, solution casting, or the like onto a base film, dried, and cured to form a primer layer.

The solvent contained in the primer composition may be removed through the drying step. The drying temperature may be 70° C. or higher, 90° C. or higher, or 110° C. or higher, for example, 70° C. to 200° C. or 90° C. to 150° C. The drying time may be, for example, 1 minute to 20 minutes, specifically, 1 minute to 10 minutes or 3 minutes to 7 minutes.

The curing of the primer layer may be carried out by light and/or heat. As an example, the primer layer may be subjected to UV curing, and the dose of light during UV curing may be 100 mJ or more, 200 mJ or more, or 300 mJ or more, for example, 100 mJ to 1,000 mJ or 300 mJ to 700 mJ.

In addition, the curing may be partial curing or full curing.

In step (3), the base film and an elastic layer are laminated through the primer layer to prepare a laminate film.

As an example, an elastic layer is prepared from raw materials for the elastic layer, and the base film and the elastic layer may then be laminated through the primer layer to prepare a laminate film.

The elastic layer is prepared from a composition comprising a polyether-block-amide. For example, a composition comprising a polyether-block-amide may be melt-extruded and cast to prepare an elastic layer. The melt-extrusion temperature may be 200° C. or higher or 220° C. or higher, for example, 200° C. to 300° C. Thereafter, the cast elastic layer may be placed on the primer layer formed on the base film and then laminated by applying a certain pressure. The step of placing the elastic layer on the primer layer may be carried out as a continuous process after the preparation of the elastic layer.

The lamination step may be carried out using, for example, a squeezing roll or the like. The pressure for lamination may be 0 kPa to 20,000 kPa, specifically, 0 kPa to 15,000 kPa, for example, 0 kPa to 10,000 kPa. Alternatively, the pressure for lamination may be 1,500 kPa or more, specifically, 3,000 kPa or more, 5,000 kPa or more, or 10,000 kPa or more, for example, 3,000 kPa to 7,000 kPa. In addition, the temperature in the lamination, specifically, the temperature of the squeezing roll, may be 0° C. or higher, 5° C. or higher, or 10° C. or higher, for example, 10° C. to 120° C.

As another example, the lamination step may be carried out by an extrusion lamination process. Specifically, the raw material for the elastic layer may be melt-extruded and laminated by casting on the primer layer formed on the base film in the previous step. Accordingly, the entire process for preparing the laminate film can be carried out in one process line, making it efficient. The extrusion temperature and lamination pressure exemplified above may be applied in this extrusion lamination process.

A laminate film, which comprises a base film; an elastic layer comprising a polyether-block-amide; and a primer layer interposed between the base film and the elastic layer, may be prepared by the above process.

### Characteristics of the Laminate Film

As the laminate film is prepared by lamination of an elastic layer comprising a polyether-block-amide and a primer-treated base film, the adhesion between the base film and the elastic layer is excellent, and the hardness and flexibility are achieved simultaneously by combining different materials, thereby securing folding durability.

According to an embodiment, when the laminate film is subjected to a 180° peel test, the adhesive force between the base film and the elastic layer is measured to be at a certain level or more.

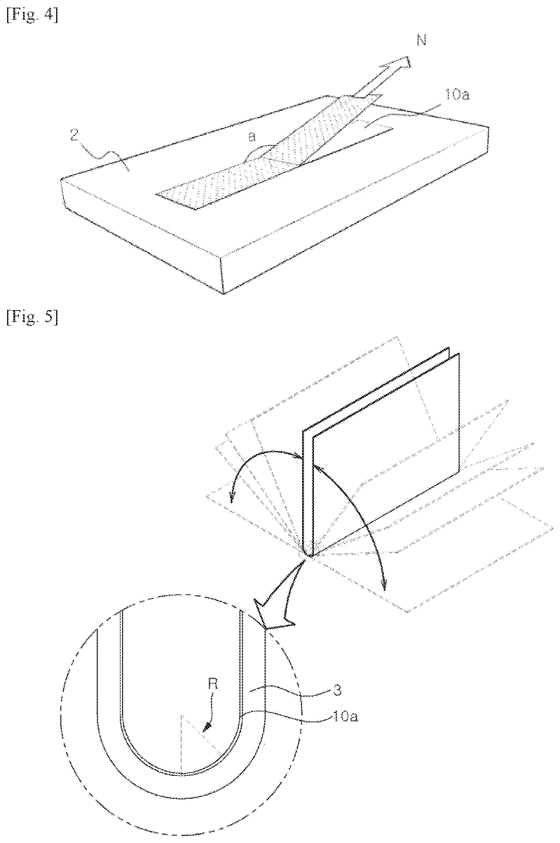

FIG. 4 shows an example of a peel test method for a laminate film sample. Referring to FIG. 4, one side of a laminate film sample (10a) is attached to a peel tester (20). While the opposite side is peeled at an angle (a) of 180°, the load (N) applied during peeling may be measured.

For the peel test, a laminate film sample may be cut to a size of, for example, 5 cm in length and 1 cm in width. The speed during the peeling may be, for example, 300 mm/minute, and the temperature may be room temperature (about 25° C.).

When the laminate film according to an embodiment is cut to a size of 5 cm in length and 1 cm in width and subjected to a 180° peel test at a speed of 300 mm/minute at room temperature, the adhesive force between the base film and the elastic layer is 15 gf/inch or more.

For example, the adhesive force between the base film and the elastic layer may be 15 gf/inch or more, 20 gf/inch or more, 25 gf/inch or more, 28 gf/inch or more, or 30 gf/inch or more, and 100 gf/inch or less, 50 gf/inch or less, 45 gf/inch or less, or 40 gf/inch or less. As a specific example, the adhesive force between the base film and the elastic layer may be 15 gf/inch to 50 gf/inch, 15 gf/inch to 40 gf/inch, 15 gf/inch to 38 gf/inch, 20 gf/inch to 50 gf/inch, 25 gf/inch to 50 gf/inch, 25 gf/inch to 45 gf/inch, or 25 gf/inch to 40 gf/inch.

If the adhesive force between the base film and the elastic layer is within the above range, when the laminate film is applied to the cover window of a foldable display, delamination between layers may not take place even after repeated folding.

Referring to FIG. 1, the interface where delamination occurs during the test may be, for example, the interface between the base film (100) and the primer layer (200), or the interface between the primer layer (200) and the elastic layer (300). Delamination may also occur partially at both of these two interfaces. Specifically, the point where delamination occurs during the test may be the interface between the primer layer (200) and the elastic layer (300). Thus, the adhesive force range exemplified above may be understood as a 180° peel strength of the interface between the primer layer and the elastic layer.

According to another embodiment, the laminate film has little deterioration in interlayer adhesion even after long-term storage; thus, its performance can be maintained at a certain level.

As a specific example, when the laminate film is stored for 96 hours at room temperature and 50% RH, the change in adhesive force calculated by the following Equation (1) may be 45% or less or 40% or less. Specifically, when the laminate film is stored for 96 hours at room temperature and 50% RH, the change in adhesive force calculated by the following Equation (1) may be 35% or less.

$$Change in adhesive force ( \% ) = [ ( {A}_{INT} - {A}_{FIN} ) / {A}_{INT} ] \times 100 \qquad ( 1 )$$

Here, A_{INT} is the adhesive force (gf/inch) between the base film and the elastic layer before storage under the above conditions, A_{FIN} is the adhesive force (gf/inch) between the base film and the elastic layer after storage under the above conditions, and each adhesive force is measured by cutting the laminate film to a size of 5 cm in length and 1 cm in width and subjecting it to a 180° peel test at a speed of 300 mm/minute at room temperature to measure the load applied between the base film and the elastic layer.

As another specific example, when the laminate film is stored for 240 hours at room temperature and 50% RH, the change in adhesive force calculated by the following Equation (1) may be 80% or less, 70% or less, or 60% or less. Specifically, when the laminate film is stored for 240 hours at room temperature and 50% RH, the change in adhesive force calculated by the following Equation (1) may be 55% or less.

$$Change in adhesive force ( \% ) = [ ( {A}_{INT} - {A}_{FIN} ) / {A}_{INT} ] \times 100 \qquad ( 1 )$$

Here, A_{INT} is the adhesive force (gf/inch) between the base film and the elastic layer before storage under the above conditions, A_{FIN} is the adhesive force (gf/inch) between the base film and the elastic layer after storage under the above conditions, and each adhesive force is measured by cutting the laminate film to a size of 5 cm in length and 1 cm in width and subjecting it to a 180° peel test at a speed of 300 mm/minute at room temperature to measure the load applied between the base film and the elastic layer.

According to another embodiment, cracks or interlayer delamination may not take place in the laminate film even after repeated folding.

FIG. 5 shows an example of a folding test method for a laminate film sample. Referring to FIG. 5, a laminate film sample (10a) is fixed on a folding tester (3) and repeatedly folded at a constant folding speed (times/sec) and a curvature (R) to determine whether interlayer delamination or cracks occur.

For the folding test, a laminate film sample may be cut to a size of, for example, 12 cm in length and 4 cm in width. The speed during the folding may be, for example, 1 time/second, and the curvature may be about 1.5 R.

As an example, when the laminate film is cut to a size of 12 cm in length and 4 cm in width and subjected to repeated folding at room temperature and a folding speed of 1 time/second while the base film is folded inward such that the radius of curvature is 1.5 R, the number of folding until interlayer delamination occurs may be 100,000 times or more. For example, the number of folding may be 100,000 times or more, 150,000 times or more, or 200,000 times or more. Within the above range, when the laminate film is applied to the cover of a flexible display device, for example, an out-folding or in-folding type device, in which the display is exposed to the outside, it can have flexible characteristics and maintain excellent performance even after repeated folding.

Specifically, if no interlayer delamination occurs even after repeated folding of 200,000 times or more in in-folding type (the base film is folded inward), and if no interlayer delamination occurs even after repeated folding of 100,000 times or more in out-folding type, it may be determined as excellent.

### Base Film (100)

The base film (100) serves as a base layer of the primer layer (200) while imparting mechanical properties to the laminate film (10).

The base film may be a polymer film or a glass substrate, specifically, a reinforced glass substrate with a thickness of less than about 100 μm. For example, the base film may comprise a polymer film or ultra-thin glass (UTG).

Specifically, the base film may be a polymer film. That is, the base film may comprise a polymer resin.

Examples of a polymer resin contained in the base film include polyester resins such as polyethylene terephthalate, polyethylene isophthalate, polyethylene naphthalate, and polybutylene terephthalate; cellulose-based resins such as diacetylcellulose and triacetylcellulose; polycarbonate-based resins; acrylic resins such as polymethyl (meth)acrylate and polyethyl (meth)acrylate; styrene-based resins such as polystyrene and acrylonitrile-styrene copolymers; polyolefin resins such as polyethylene, polypropylene, polyolefins with cyclo- or norbornene structures, and ethylene-propylene copolymers; vinyl chloride-based resin; amide resins such as nylon and aromatic polyamide; imide-based resins; polyamide-imide-based resins; polyethersulfone resins; polyurethane resins; sulfone-based resins; polyetheretherketone-based resins; sulfated polyphenylene resins; vinyl alcohol-based resins; vinylidene chloride-based resins; vinyl butyral-based resins; allylate-based resins; polyoxymethylene-based resins; and epoxy-based resins. They may be used alone or in combination of two or more.

The base film may further comprise a filler in addition to the polymer resin. As an example, the base film may comprise a polyimide-based resin and a filler.

The filler may be at least one selected from the group consisting of barium sulfate, silica, and calcium carbonate. As the base film comprises the filler, it is possible to enhance the roughness and windability and to enhance the sliding performance and the effect of improving scratches in the preparation of the film.

The filler may have a particle diameter of 0.01 μm to less than 1.0 μm. For example, the particle diameter of the filler may be 0.05 μm to 0.9 μm or 0.1 μm to 0.8 μm, but it is not limited thereto.

The filler may be employed in an amount of 0.01% by weight to 3% by weight based on the total weight of the base film. For example, the filler may be employed in an amount of 0.05% by weight to 2.5% by weight, 0.1% by weight to 2% by weight, or 0.2% by weight to 1.7% by weight, based on the total weight of the base film, but it is not limited thereto.

The base film may have a thickness of 20 μm or more, 30 μm or more, 40 μm or more, 50 μm or more, or 100 μm or more, and 500 μm or less, 400 μm or less, 300 μm or less, or 200 μm or less. As a specific example, the thickness of the base film may be 20 μm to 500 μm, more specifically 40 μm to 200 μm or 50 μm to 200 μm.

The base film may have optical properties and mechanical properties adjusted to certain ranges.

The base film may have a haze of 3% or less. For example, the haze of the base film may be 2% or less, 1.5% or less, or 1% or less, but it is not limited thereto.

The base film may have a yellow index (YI) of 5 or less. For example, the yellow index of the base film may be 4 or less, 3.8 or less, 2.8 or less, 2.5 or less, 2.3 or less, or 2.1 or less, but it is not limited thereto.

The base film may have a modulus of 5 GPa or more. For example, the modulus of the base film may be 5.2 GPa or more, 5.5 GPa or more, 6.0 GPa or more, 10 GPa or less, 5 GPa to 10 GPa, or 7 GPa to 10 GPa, but it is not limited thereto.

The base film may have a light transmittance of 80% or more. For example, the light transmittance of the base film may be 85% or more, 88% or more, 89% or more, 80% to 99%, or 85% to 99%, but it is not limited thereto.

The base film may have a compressive strength of 0.4 kgf/μm or more. Specifically, the compressive strength of the base film may be 0.45 kgf/μm or more, or 0.46 kgf/μm or more, but it is not limited thereto.

The base film may have a surface hardness of HB or higher. Specifically, the surface hardness of the base film may be H or higher, or 2H or higher, but it is not limited thereto.

The base film may have a tensile strength of 15 kgf/mm² or more. Specifically, the tensile strength of the base film may be 18 kgf/mm² or more, 20 kgf/mm² or more, 21 kgf/mm² or more, or 22 kgf/mm² or more, but it is not limited thereto.

The base film may have an elongation of 15% or more. Specifically, the elongation of the base film may be 16% or more, 17% or more, or 17.5% or more, but it is not limited thereto.

### Polyimide-Based Resin

As an example, the base film may comprise a polyimide-based resin. Specifically, the base film may be a transparent polyimide-based film. The polyimide-based resin may be prepared by simultaneously or sequentially reacting reactants that comprise a diamine compound and a dianhydride compound. Specifically, the polyimide-based resin may comprise a polyimide-based polymer prepared by polymerizing a diamine compound and a dianhydride compound. The polyimide-based resin may comprise an imide repeat unit derived from the polymerization of a diamine compound and a dianhydride compound. In addition, the polyimide-based resin may be polymerized by further comprising a dicarbonyl compound. As a result, it may comprise a polyamide-imide-based polymer that further comprises an amide repeat unit derived from the polymerization of a diamine compound and a dicarbonyl compound.

The diamine compound is not particularly limited, but it may be, for example, an aromatic diamine compound that contains an aromatic structure. For example, the diamine compound may be a compound represented by the following Formula 1.

$${H}_{2} N — {( E )}_{e} — {NH}_{2} \qquad [ Formula 1 ]$$

In Formula 1, E is selected from a substituted or unsubstituted divalent C₆-C₃₀ aliphatic cyclic group, a substituted or unsubstituted divalent C₄-C₃₀ heteroaliphatic cyclic group, a substituted or unsubstituted divalent C₆-C₃₀ aromatic cyclic group, a substituted or unsubstituted divalent C₄-C₃₀ heteroaromatic cyclic group, a substituted or unsubstituted C₁-C₃₀ alkylene group, a substituted or unsubstituted C₂-C₃₀ alkenylene group, a substituted or unsubstituted C₂-C₃₀ alkynylene group, —C(═O)—, —CH(OH)—, —S(═O)₂—, —Si(CH₃)₂—, —C(CH₃)₂—, and —C(CF₃)₂—. e is selected from integers of 1 to 5. When e is 2 or more, the Es may be the same as, or different from, each other.

In the present specification, the term “substituted” means to be substituted with at least one substituent group selected from the group consisting of deuterium, —F, —Cl, —Br, —I, a hydroxyl group, a cyano group, a nitro group, an amino group, an amido group, a hydrazine group, a hydrazone group, an ester group, a ketone group, a carboxyl group, a substituted or unsubstituted C₁-C₃₀ alkyl group, a substituted or unsubstituted C₂-C₃₀ alkenyl group, a substituted or unsubstituted C₂-C₃₀ alkynyl group, a substituted or unsubstituted C₁-C₃₀ alkoxy group, a substituted or unsubstituted C₆-C₃₀ alicyclic organic group, a substituted or unsubstituted C₄-C₃₀ heterocyclic group, a substituted or unsubstituted C₆-C₃₀ aryl group, and a substituted or unsubstituted C₄-C₃₀ heteroaryl group. Two substituents adjacent to each other may be linked to form a ring.

(E)ₑ in Formula 1 may be selected from the groups represented by the following Formulae 1-1a to 1-14a, but it is not limited thereto.

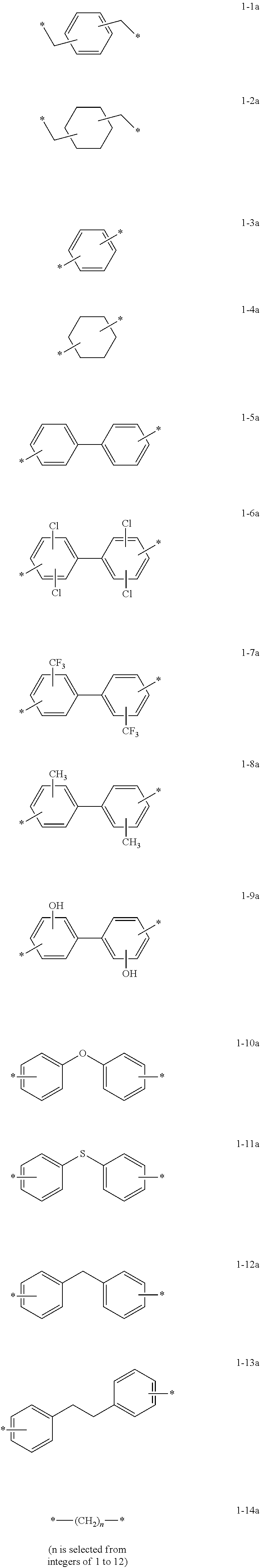

Specifically, (E)ₑ in Formula 1 may be selected from the groups represented by the following Formulae 1-1b to 1-13b, but it is not limited thereto.

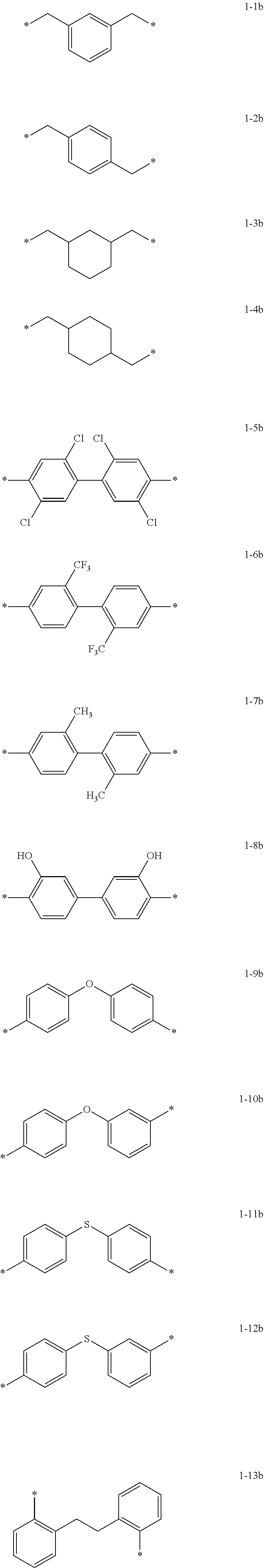

More specifically, (E)ₑ in the above Formula 1 may be the group represented by the above Formula 1-6b.

In an embodiment, the diamine compound may comprise a compound having a fluorine-containing substituent. Alternatively, the diamine compound may be composed of a compound having a fluorine-containing substituent. In such an event, the fluorine-containing substituent may be a fluorinated hydrocarbon group and specifically may be a trifluoromethyl group. But it is not limited thereto.

In an embodiment, one kind of diamine compound may be used as the diamine compound. That is, the diamine compound may be composed of a single component.

For example, the diamine compound may comprise 2,2′-bis(trifluoromethyl)-4,4′-diaminobiphenyl (TFDB) represented by the following formula, but it is not limited thereto.

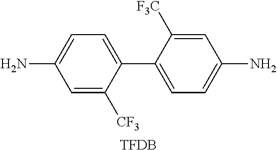

The dianhydride compound has a low birefringence value, so that it can contribute to enhancements in the optical properties such as transmittance of a film that comprises the polyimide-based resin.

The dianhydride compound is not particularly limited, but it may be an aromatic dianhydride compound that contains an aromatic structure. For example, the aromatic dianhydride compound may be a compound represented by the following Formula 2.

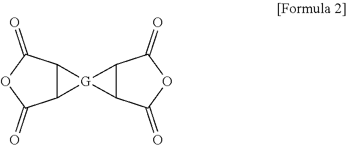

In Formula 2, G may be a group selected from a substituted or unsubstituted tetravalent C₆-C₃₀ aliphatic cyclic group, a substituted or unsubstituted tetravalent C₄-C₃₀ heteroaliphatic cyclic group, a substituted or unsubstituted tetravalent C₆-C₃₀ aromatic cyclic group, or a substituted or unsubstituted tetravalent C₄-C₃₀ heteroaromatic cyclic group, wherein the aliphatic cyclic group, the heteroaliphatic cyclic group, the aromatic cyclic group, or the heteroaromatic cyclic group may be present alone, may be fused to each other to form a condensed ring, or may be bonded by a bonding group selected from a substituted or unsubstituted C₁-C₃₀ alkylene group, a substituted or unsubstituted C₂-C₃₀ alkenylene group, a substituted or unsubstituted C₂-C₃₀ alkynylene group, —O—, —S—, —C(═O)—, —CH(OH)—, —S(═O)₂—, —Si(CH₃)₂—, —C(CH₃)₂—, and —C(CF₃)₂—.

G in the above Formula 2 may be selected from the groups represented by the following Formulae 2-1a to 2-9a, but it is not limited thereto.

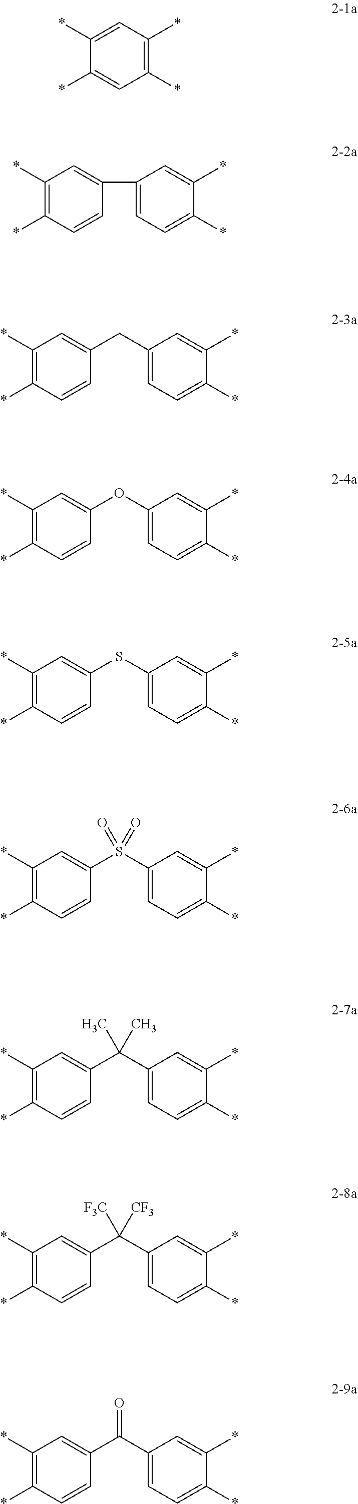

For example, G in the above Formula 2 may be the group represented by the above Formula 2-8a.

In an embodiment, the dianhydride compound may comprise a compound having a fluorine-containing substituent. Alternatively, the dianhydride compound may be composed of a compound having a fluorine-containing substituent. In such an event, the fluorine-containing substituent may be a fluorinated hydrocarbon group and specifically may be a trifluoromethyl group. But it is not limited thereto.

In another embodiment, the dianhydride compound may be composed of a single component or a mixture of two components.

For example, the dianhydride compound may comprise 2,2′-bis-(3,4-dicarboxyphenyl) hexafluoropropane dianhydride (6-FDA) represented by the following formula, but it is not limited thereto.

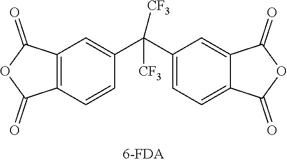 [SMILES: O=C1OC(=O)c2cc(C(c3ccc4c(c3)C(=O)OC4=O)(C(F)(F)F)C(F)(F)F)ccc21]

The diamine compound and the dianhydride compound may be polymerized to form a polyamic acid.

Subsequently, the polyamic acid may be converted to a polyimide through a dehydration reaction.

The polyimide may comprise a repeat unit represented by the following Formula A.

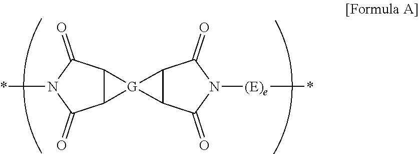

In Formula A, E, G, and e are as described above.

For example, the polyimide may comprise a repeat unit represented by the following Formula A-1, but it is not limited thereto.

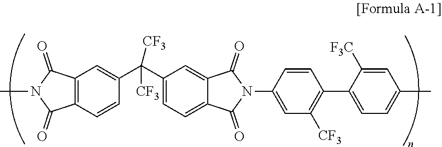

In Formula A-1, n may be an integer of 1 to 400.

The dicarbonyl compound is not particularly limited, but it may be, for example, a compound represented by the following Formula 3.

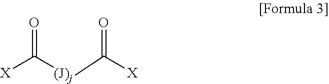

In Formula 3, J is selected from a substituted or unsubstituted divalent C₆-C₃₀ aliphatic cyclic group, a substituted or unsubstituted divalent C₄-C₃₀ heteroaliphatic cyclic group, a substituted or unsubstituted divalent C₆-C₃₀ aromatic cyclic group, a substituted or unsubstituted divalent C₄-C₃₀ heteroaromatic cyclic group, a substituted or unsubstituted C₁-C₃₀ alkylene group, a substituted or unsubstituted C₂-C₃₀ alkenylene group, a substituted or unsubstituted C₂-C₃₀ alkynylene group, —O—, —S—, —C(═O)—, —CH(OH)—, —S(═O)₂—, —Si(CH₃)₂—, —C(CH₃)₂—, and —C(CF₃)₂—. j is selected from integers of 1 to 5. When j is 2 or more, the Js may be the same as, or different from, each other. X is a halogen atom. Specifically, X may be F, Cl, Br, I, or the like. More specifically, X may be Cl, but it is not limited thereto.

(J)ⱼ in the above Formula 3 may be selected from the groups represented by the following Formulae 3-1a to 3-14a, but it is not limited thereto.

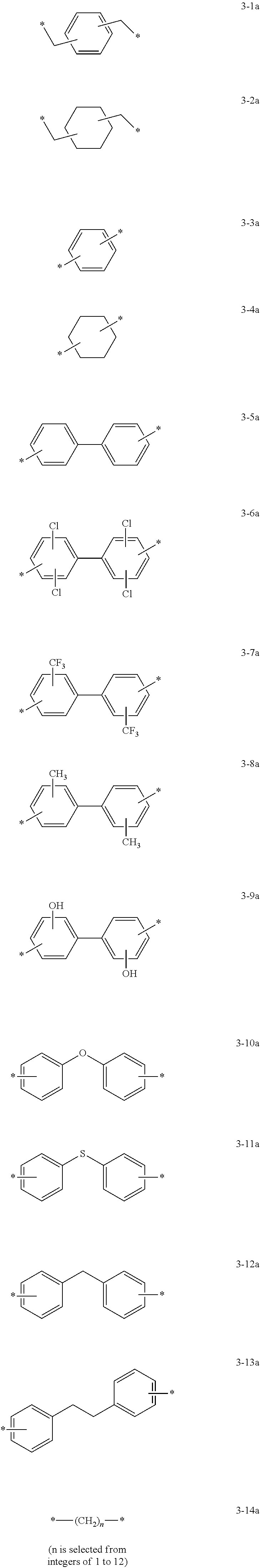

Specifically, (J)ⱼ in the above Formula 3 may be selected from the groups represented by the following Formulae 3-1b to 3-8b, but it is not limited thereto.

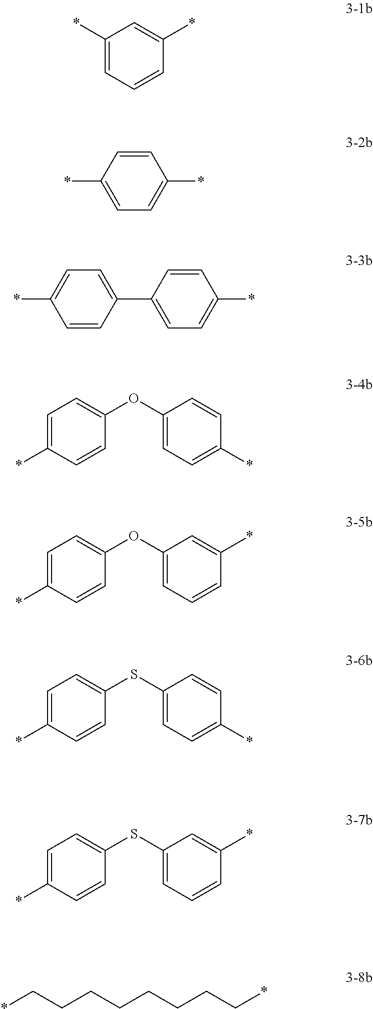

More specifically, (J)ⱼ in Formula 3 may be the group represented by the above Formula 3-1b, the group represented by the above Formula 3-2b, or the group represented by the above Formula 3-3b.

In an embodiment, a mixture of at least two kinds of dicarbonyl compounds different from each other may be used as the dicarbonyl compound. If two or more dicarbonyl compounds are used, at least two dicarbonyl compounds in which (J)ⱼ in the above Formula 3 is selected from the groups represented by the above Formulae 3-1b to 3-8b may be used as the dicarbonyl compound.

In another embodiment, the dicarbonyl compound may be an aromatic dicarbonyl compound that contains an aromatic structure.

For example, the dicarbonyl compound may comprise a first dicarbonyl compound and/or a second dicarbonyl compound different from the first dicarbonyl compound.

The first dicarbonyl compound and the second dicarbonyl compound may be an aromatic dicarbonyl compound, respectively.

The first dicarbonyl compound and the second dicarbonyl compound may be aromatic dicarbonyl compounds different from each other, but they are not limited thereto.

If the first dicarbonyl compound and the second dicarbonyl compound are an aromatic dicarbonyl compound, respectively, they comprise a benzene ring. Thus, they can contribute to improvements in the mechanical properties such as surface hardness and tensile strength of a film thus produced that comprises the polyamide-imide resin.

The dicarbonyl compound may comprise terephthaloyl chloride (TPC), isophthaloyl chloride (IPC), and 1,1′-biphenyl-4,4′-dicarbonyl dichloride (BPDC), as represented by the following formulae, or a combination thereof. But it is not limited thereto.

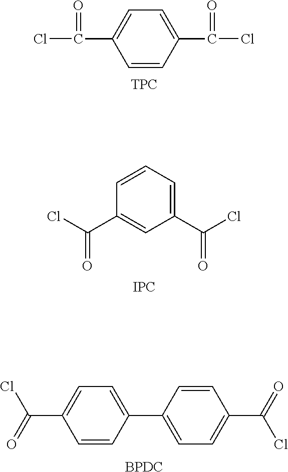

For example, the first dicarbonyl compound may comprise BPDC, and the second dicarbonyl compound may comprise TPC, but they are not limited thereto.

Specifically, if BPDC is used as the first dicarbonyl compound and TPC is used as the second dicarbonyl compound in a proper combination, a film that comprises the polyamide-imide-based resin thus produced may have high oxidation resistance.

Alternatively, the first dicarbonyl compound may comprise IPC (isophthaloyl chloride), and the second dicarbonyl compound may comprise TPC, but they are not limited thereto.

Specifically, if IPC is used as the first dicarbonyl compound and TPC is used as the second dicarbonyl compound in a proper combination, a film that comprises the polyamide-imide-based resin thus produced may have high oxidation resistance, along with reduced manufacturing costs.

The diamine compound and the dicarbonyl compound may be polymerized to form a repeat unit represented by the following Formula B.

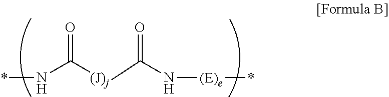

In Formula B, E, J, e, and j are as described above.

For example, the diamine compound and the dicarbonyl compound may be polymerized to form amide repeat units represented by the following Formulae B-1 and B-2.

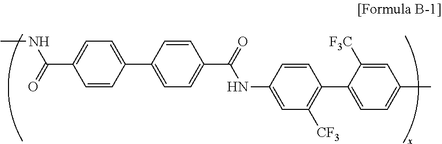

In Formula B-1, x is an integer of 1 to 400.

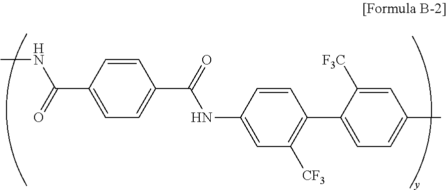

In Formula B-2, y is an integer of 1 to 400.

### Polyester-Based Film

As another example, the base film may comprise a polyester-based resin. Specifically, the base film may be a transparent polyester-based film.

The polyester-based resin may be a homopolymer resin or a copolymer resin in which a dicarboxylic acid and a diol are polycondensed. In addition, the polyester-based resin may be a blend resin in which the homopolymer resins or the copolymer resins are mixed.

Examples of the dicarboxylic acid include terephthalic acid, isophthalic acid, orthophthalic acid, 2,5-naphthalene dicarboxylic acid, 2,6-naphthalene dicarboxylic acid, 1,4-naphthalene dicarboxylic acid, 1,5-naphthalene dicarboxylic acid, diphenyl dicarboxylic acid, diphenoxyethane dicarboxylic acid, diphenyl sulfone dicarboxylic acid, anthracene dicarboxylic acid, 1,3-cyclopentane dicarboxylic acid, 1,3-cyclohexane dicarboxylic acid, 1,4-cyclohexane dicarboxylic acid, hexahydroterephthalic acid, hexahydroisophthalic acid, malonic acid, dimethyl malonic acid, succinic acid, 3,3-diethyl succinic acid, glutaric acid, 2,2-dimethylglutaric acid, adipic acid, 2-methyladipic acid, pimelic acid, azelaic acid, sebacic acid, suberic acid, dodecadicarboxylic acid, and the like.

In addition, examples of the diol include ethylene glycol, propylene glycol, hexamethylene glycol, neopentyl glycol, 1,2-cyclohexanedimethanol, 1,4-cyclohexanedimethanol, decamethylene glycol, 1,3-propanediol, 1,4-butanediol, 1,5-pentanediol, 1,6-hexanediol, 2,2-bis(4-hydroxyphenyl) propane, bis(4-hydroxyphenyl) sulfone, and the like.

Preferably, the polyester-based resin may be an aromatic polyester-based resin having excellent crystallinity. For example, it may have a polyethylene terephthalate (PET) resin as a main component.

When the base film is a polyester-based film, the polyester-based film may comprise a polyester-based resin, specifically a PET resin in an amount of about 85% by weight or more, more specifically, 90% by weight or more, 95% by weight or more, or 99% by weight or more. As another example, the polyester-based film may further comprise a polyester-based resin other than the PET resin. Specifically, the polyester-based film may further comprise up to about 15% by weight of a polyethylene naphthalate (PEN) resin. More specifically, the polyester-based film may further comprise a PEN resin in an amount of about 0.1% by weight to 10% by weight or about 0.1% by weight to 5% by weight.

The polyester-based film having the above composition may have increased crystallinity and enhanced mechanical properties in terms of tensile strength and the like in the process of preparing the same through heating, stretching, and the like.

### Primer Layer (200)

The primer layer (200) is interposed between the base film (100) and the elastic layer (300).

The primer layer comprises a binder resin. For example, it may comprise a curable resin, specifically, a UV curable resin.

As an example, the primer layer may comprise a polyester acrylate. A polyester acrylate has low viscosity, good workability, and good compatibility with various oligomers or polymers.

The polyester acrylate may have a structure in which an acrylate group (or acryloyl group) is substituted in the polyester main chain.

The polyester acrylate may have, for example, 1 to 6 or 1 to 3 acrylate groups.

The polyester acrylate may be in the form of an oligomer or a polymer. For example, the polyester acrylate may have a weight average molecular weight (Mw) of 1,000 or more, 2,000 or more, 2,500 or more, 3,000 or more, or 3,500 or more, and may be 50,000 or less, 30,000 or less, 20,000 or less, 10,000 or less, 7,000 or less, 5,000 or less, or 4,500 or less. As a specific example, the weight average molecular weight of the polyester acrylate may be 1,000 to 7,000.

As another example, the primer layer may comprise an acrylamide-based compound. Specifically, the acrylamide-based compound may be represented by the following Formula I.

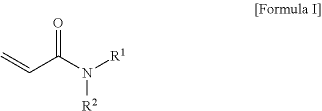

Here, R¹ and R² may each independently be hydrogen, a substituted or unsubstituted monovalent C₆-C₃₀ aliphatic cyclic group, a substituted or unsubstituted monovalent C₄-C₃₀ heteroaliphatic cyclic group, a substituted or unsubstituted monovalent C₆-C₃₀ aromatic cyclic group, a substituted or unsubstituted monovalent C₄-C₃₀ heteroaromatic cyclic group, a substituted or unsubstituted C₁-C₃₀ alkyl group, a substituted or unsubstituted C₂-C₃₀ alkenyl group, or a substituted or unsubstituted C₂-C₃₀ alkynyl group.

As a specific example, the acrylamide-based compound may be dimethylacrylamide.

As another example, the primer layer may comprise a polyester acrylate and an acrylamide-based compound. As the weight ratio between the polyester acrylate and the acrylamide-based compound in the primer layer is adjusted to a certain range, interlayer adhesion can be further enhanced.

For example, the primer layer may comprise the acrylamide-based compound in an amount of 1 part by weight or more, 5 parts by weight or more, 10 parts by weight or more, 15 parts by weight or more, or 20 parts by weight or more, relative to 100 parts by weight of the polyester acrylate. In addition, the primer layer may comprise the acrylamide-based compound in an amount of 60 parts by weight or less, 50 parts by weight or less, 40 parts by weight or less, 30 parts by weight or less, or 25 parts by weight or less, relative to 100 parts by weight of the polyester acrylate. Specifically, the primer layer may comprise the acrylamide-based compound in an amount of 5 parts by weight to 40 parts by weight relative to 100 parts by weight of the polyester acrylate.

As another example, the primer layer may further comprise other acrylic resins, specific examples of which are as described above in the preparation of the primer composition.

In addition, the primer layer may further comprise a photoinitiator, specific examples of which are as described above in the preparation of the primer composition.

The photoinitiator may be employed in the primer layer in an amount of 1 part by weight to 10 parts by weight or 3 parts by weight to 7 parts by weight, relative to 100 parts by weight of the total weight of the binder resin (for example, the polyester acrylate and acrylamide-based compound).

The primer layer may have a thickness of 20 nm to 200 nm. Specifically, the thickness of the primer layer may be 20 nm to 190 nm, 20 nm to 180 nm, 20 nm to 160 nm, 20 nm to 130 nm, 20 nm to 120 nm, 20 nm to 110 nm, 20 nm to 80 nm, 30 nm to 200 nm, 30 nm to 190 nm, 30 nm to 180 nm, 30 nm to 160 nm, 30 nm to 130 nm, 30 nm to 120 nm, 30 nm to 110 nm, 30 nm to 100 nm, or 30 nm to 80 nm. Within the above thickness range, adhesion between the base film and the elastic layer may increase.

### Elastic Layer (300)

The elastic layer (300) comprises a polyether-block-amide (PEBA).

The polyether-block-amide comprises two phases: a polyamide segment, which is a rigid segment, and a polyether segment, which is a soft segment.

The rigid segment may be a crystalline segment or a semi-crystalline segment. The soft segment may be an amorphous segment. For example, the amorphous segment may be a matrix, and the crystalline segment may be distributed in the matrix.

As the polyether-block-amide comprises both a rigid segment and a soft segment together, the elastic layer can have relatively strong mechanical strength and, at the same time, have flexible and/or elastomer characteristics.

The elastic layer may have relatively strong mechanical strength and, at the same time, have flexible and/or elastomer characteristics.

The polyamide segment may have a melting point of about 80° C. or higher, specifically, about 130° C. to 200° C., about 150° C. to 200° C., or 170° C. to 200° C. It is a substantially crystalline phase that constitutes the hard segment. In addition, the polyether segment may have a glass transition temperature of about-40° C. or lower, specifically-80° C. to −40° C. It is present in a low-temperature region and may constitute a substantially amorphous soft segment.

The polyether-block-amide may be one in which a polyamide containing two or more carboxyl groups in the molecule and an ether containing two or more hydroxyl groups are combined in the molecule.

The elastic layer may comprise a polyether-block-amide. The polyether-block-amide may comprise at least one copolymer comprising a polyether block and a polyamide block. The polyether-block-amide thus comprises at least one polyether block and at least one polyamide block.

A copolymer (polyether-block-amide) comprising a polyether block and a polyamide block may be one in which a polyether block containing a reactive end and a polyamide block containing a reactive end are polycondensed.

As an example, the polyether-block-amide may be a polycondensed polymer comprising a polyamide block containing a diamine end and a polyoxyalkylene block containing a dicarboxyl end.

As another example, the polyether-block-amide may be a polycondensed polymer comprising a polyamide block containing a dicarboxyl end and a polyoxyalkylene block containing a diamine end.

The polyoxyalkylene block may be obtained by a cyanoethylation reaction and a hydrogenation reaction of an aliphatic α,ω-dihydroxylated polyoxyalkylene block known as polyetherdiol.

The polyether-block-amide may be a polycondensed polymer comprising a polyamide block containing a dicarboxyl end and a polyetherdiol block. In such an event, the polyether-block-amide is a polyetheresteramide.

As an example, a polyamide block comprising a dicarboxylic chain end may comprise a polycondensed polymer of a polyamide precursor in the presence of a chain-limiting dicarboxylic acid.

As an example, a polyamide block comprising a diamine chain end may comprise a polycondensed polymer of a polyamide precursor in the presence of a chain-limiting diamine.

As an example, a polyamide block comprising a dicarboxylic chain end may comprise a polycondensed polymer of an α,ω-aminocarboxylic acid, lactam, or dicarboxylic acid and a diamine in the presence of a chain-limiting dicarboxylic acid.

Polyamide 12 or polyamide 6 is preferred as the polyamide block.

The polyether-block-polyamide may comprise blocks with randomly distributed unit structures.

Advantageously, the following three types of polyamide blocks may be adopted.

As a first type, the polyamide block may comprise a polycondensed polymer of a carboxylic acid and an aliphatic or aryl aliphatic diamine. The carboxylic acid may have 4 to 20 carbon atoms, preferably 6 to 18 carbon atoms. The aliphatic or aryl aliphatic diamine may have 2 to 20 carbon atoms, preferably 6 to 14 carbon atoms.

The carboxylic acid, specifically dicarboxylic acid, may be, for example, 1,4-cyclohexanedicarboxylic acid, 1,2-cyclohexyldicarboxylic acid, 1,4-butanedioic acid, adipic acid, azelaic acid, suberic acid, sebacic acid, 1,12-dodecanedicarboxylic acid, 1,14-tetradecanedicarboxylic acid, 1,18-octadecanedicarboxylic acid, terephthalic acid, isophthalic acid, naphthalenedicarboxylic acid, and dimerized fatty acid.

The diamine may be, for example, 1,5-tetramethylenediamine, 1,6-hexamethylenediamine, 1,10-decamethylenediamine, 1,12-dodecamethylenediamine, trimethyl-1,6-hexamethylenediamine, 2-methyl-1,5-pentamethylenediamine, isomers of bis(3-methyl-4-aminocyclohexyl) methane (BMACM), 2,2-bis(3-methyl-4-aminocyclohexyl) propane (BMACP), (bis(para-aminocyclohexyl) methane (PACM), isophoronediamine (IPD), 2,6-bis(aminomethyl) norbornane (BAMN), piperazine (Pip), meta-xylylenediamine (MXD), and para-xylylenediamine (PXD).

Specifically, the first type of the polyamide block may comprise PA 412, PA 414, PA 418, PA 610, PA 612, PA 614, PA 618, PA 912, PA 1010, PA 1012, PA 1014, PA 1018, MXD6, PXD6, MXD10, or PXD10.

As a second type, the polyamide block may comprise a polycondensed polymer of at least one α,ω-aminocarboxylic acid and/or at least one lactam each having 6 to 12 carbon atoms in the presence of a dicarboxylic acid or a diamine having 4 to 12 carbon atoms. Examples of the lactam include caprolactam, oenantholactam, and lauryllactam. Examples of the α,ω-aminocarboxylic acid include aminocaproic acid, 7-aminoheptanoic acid, 11-aminoundecanoic acid, and 12-aminododecanoic acid. Specifically, the second type of the polyamide block may comprise polyamide 11, polyamide 12, or polyamide 6.

As a third type, the polyamide block may comprise a polycondensed polymer of at least one α,ω-aminocarboxylic acid (or at least one lactam), at least one diamine, and at least one dicarboxylic acid. In such an event, the polyamide (PA) block may be prepared by polycondensation of a diamine, a diacid, and a comonomer (or comonomers) as follows.

As the diamine, for example, a linear aliphatic diamine, an aromatic diamine, or the like be employed. As the diacid, for example, an alicyclic dibasic acid, an aliphatic dibasic acid, an aromatic dibasic acid, or the like may be employed. As the diacid, for example, a dicarboxylic acid may be employed. The comonomer may be selected from lactams, α,ω-aminocarboxylic acids, and mixtures comprising substantially equal moles of one or more diamines and one or more dicarboxylic acids. The comonomer may be employed in an amount of 50% by weight or less, preferably 20% by weight or less, advantageously 10% by weight or less, based on the total of the combined polyamide precursor monomers.

The polycondensation reaction according to the third type may be carried out in the presence of a chain-limiting agent selected from dicarboxylic acids. Specifically, a dicarboxylic acid may be used as a chain-limiting agent, and the dicarboxylic acid may be introduced in a stoichiometric excess relative to the one or more diamines.

In an alternative form of the third type, the polyamide block may comprise a polycondensed polymer of at least two α,ω-aminocarboxylic acids having 6 to 12 carbon atoms, or at least two lactams, or lactams and aminocarboxylic acids with different numbers of carbon atoms, optionally in the presence of a chain-limiting agent. The aliphatic α,ω-aminocarboxylic acid may be, for example, aminocaproic acid, 7-aminoheptanoic acid, 11-aminoundecanoic acid, or 12-aminododecanoic acid. The lactam may be, for example, caprolactam, oenantholactam, or lauryllactam.

The aliphatic diamine may be, for example, hexamethylenediamine, dodecamethylene-diamine, or trimethylhexamethylenediamine.

The alicyclic diacid may be, for example, 1,4-cyclohexanedicarboxylic acid. In addition, the aliphatic diacid may be, for example, butanedioic acid, adipic acid, azelaic acid, suberic acid, sebacic acid, dodecanedicarboxylic acid, dimer fatty acids (preferably, dimer ratio of 98% or more; preferably hydrogenated; sold under the trade name Pripol by Uniqema or Empol by Henkel), or polyoxyalkylene-α,ω-diacid.

The aromatic diacid may be, for example, terephthalic acid or isophthalic acid.

The alicyclic diamine may be, for example, isomers of bis(3-methyl-4-aminocyclohexyl) methane (BMACM) and 2,2-bis(3-methyl-4-aminocyclohexyl) propane (BMACP) or bis(para-aminocyclohexyl) methane (PACM).

Other diamines include, for example, isophorone diamine (IPDI), 2,6-bis(aminomethyl) norbonane (BAMN), and piperazine.

Examples of an aryl aliphatic diamine include meta-xylylenediamine (MXD) and para-xylylene diamine (PXD), but it is not limited thereto.

Examples of the third type of the polyamide block include PA 66/6, PA 66/610/11/12, and the like.

In the PA 66/6, 66 indicates a hexamethylenediamine unit condensed with adipic acid, and 6 indicates a unit introduced by condensation of caprolactam.

In the PA 66/610/11/12, 66 indicates a hexamethylenediamine unit condensed with adipic acid, 610 indicates a hexamethylenediamine unit condensed with sebacic acid, 11 indicates a unit introduced by condensation of aminoundecanoic acid, and 12 indicates a unit introduced by condensation of lauryllactam.

The polyamide block may have a number average molecular weight of 400 to 20,000, specifically 500 to 10,000.

The polyether block may be, for example, at least one polyalkylene ether polyol, for example, polyalkylene ether diol. Specifically, it may be selected from polyethylene glycol (PEG), polypropylene glycol (PPG), polytrimethylene glycol (PO3G), polytetramethylene glycol (PTMG), mixtures thereof, and copolymers thereof.

The polyether block may comprise a polyoxyalkylene unit containing an NH₂ chain end. The unit may be introduced by cyanoacetylating an aliphatic α,ω-dihydroxy polyoxyalkylene unit known as polyetherdiol. Specifically, Jeffamine (e.g., Jeffamine™ D400, D2000, ED2003, or XTJ542 from Huntsman) may be used.

The at least one polyether block comprises, for example, at least one polyether selected from polyalkyleneetherpolyols such as PEG, PPG, PO3G, and PTMG, polyethers containing NH₂ at a chain end and polyoxyalkylene sequences, copolymers in which they are arranged randomly and/or in blocks (ether copolymers), and mixtures thereof.

The polyether block may be employed in an amount of 10% by weight to 80% by weight, specifically, 20% by weight to 60% by weight or 20% by weight to 40% by weight, based on the total weight of the copolymer. The polyether block may have a number average molecular weight of 200 to 1,000, specifically 400 to 800 or 500 to 700.

The polyether block may be introduced from polyethylene glycol, polypropylene glycol, or polytetramethylene glycol.

The polyether block may be copolymerized with a polyamide block containing a carboxyl end to form a polyether-block-amide.

The polyether block may be converted to a polyetherdiamine through amination and then condensed with a polyamide block containing a carboxyl end to form a polyether-block-amide.

The polyether block may be mixed with a polyamide precursor and a chain-limiting agent to form a polyether-block-amide containing statistically dispersed units.

The polyether may be, for example, polyethylene glycol (PEG), polypropylene glycol (PPG), or polytetramethylene glycol (PTMG). Polytetramethylene glycol is also known as polytetrahydrofuran (PTHF). The polyether block may be introduced into the chain of a polyether-block-amide from a diol or diamine form, wherein the polyether blocks are referred to as PEG blocks, PPG blocks, and PTMG blocks, respectively.

In addition, even if the polyether block comprises a unit other than a unit derived from ethylene glycol (—OC₂H₄—), propylene glycol (—O—CH₂—CH(CH₃)—), or tetramethylene glycol (—O—(CH₂)₄—), such a polyether block should be understood as falling within the scope of the embodiment.

The polyamide block may have a number average molecular weight of 300 to 15,000 or 600 to 5,000. The polyether block may have a number average molecular weight of 100 to 6,000, preferably 200 to 3,000.

Specifically, the content of the polyamide block contained in the polyether-block-amide may be 50% by weight or more based on the total polyether-block-amide. This may mean the possibility of statistical distribution within the polymer chain. Specifically, the content of the polyamide block may be 50% by weight to 80% by weight. In addition, the content of the polyether block contained in the polyether-block-amide may be 20% by weight to 50% by weight based on the total polyether-block-amide.

The ratio of number average molecular weights of the polyamide block and the polyether block of the copolymer may be, for example, 1:0.25 to 1:1. Specifically, the number average molecular weight of the polyamide block/the number average molecular weight of the polyether block of the copolymer may be 1,000/1,000, 1,300/650, 2,000/1,000, 2,600/650, or 4,000/1,000.

The polyether-block-amide may be prepared by a two-step method, which comprises a first step of preparing a polyamide block and a polyether block, and a second step of polycondensing the polyamide block and the polyether block to prepare an elastic polyether-block-amide. Alternatively, the polyether-block-amide may be prepared by polycondensation of monomers in a single step.

The polyether-block-amide may have a Shore D hardness of, for example, 20 to 75, specifically 30 to 70.

The polyether-block-amide may have an intrinsic viscosity of 0.8 dl/g to 2.5 dl/g as measured with metacresol at 25° C. The intrinsic viscosity may be measured according to ISO 307:2019. Specifically, the intrinsic viscosity in a solution may be measured in a metacresol solution with a concentration of 0.5% by weight at 25° C. using an Ubbelohde viscometer.

Examples of the polyether-block-amide include Pebax™ and Pebax™ Rnew™ from Arkema, and VESTAMID™ E from Evonik, but it is not limited thereto.

The optical properties of the elastic layer may be adjusted within a certain range. Thus, it is advantageous for application to a cover window of a display device.

The elastic layer may have a haze of, for example, 3% or less, specifically, 2% or less, 1.5% or less, or 1.2% or less. In addition, the haze of the elastic layer may be 0.01% or more or 0.1% or more.

The elastic layer may have an average visible light transmittance of, for example, 85% or more, specifically, 88% or more or 90% or more. In addition, the average visible light transmittance of the elastic layer may be 99.99% or less.

The elastic layer may have a thickness of 20 μm or more, 30 μm or more, 50 μm or more, or 100 μm or more, and 500 μm or less, 400 μm or less, 300 μm or less, or 200 μm or less. As a specific example, the thickness of the base film may be 20 μm to 500 μm, more specifically 50 μm to 200 μm.

### Hard Coating Layer

The laminate film according to an embodiment may optionally further comprise a hard coating layer on the base film (100).

The hard coating layer may have an upper side and a lower side, of which the lower side may face the base film, and the upper side may be the outermost side exposed to the outside. In addition, the lower side of the hard coating layer may be in direct contact with one side of the base film or may be bonded to one side of the base film through an additional coating layer. As an example, the hard coating layer may be directly formed on one side of the base film.

The hard coating layer may enhance the mechanical properties and/or optical properties of the laminate film. In addition, the hard coating layer may further comprise antiglare, antifouling, antistatic functions, and the like.

The hard coating layer may comprise at least one of an organic component, an inorganic component, and an organic-inorganic composite component as a hard coating agent.

As an example, the hard coating layer may comprise an organic resin. Specifically, the organic resin may be a curable resin. Thus, the hard coating layer may be a curable coating layer. In addition, the organic resin may be a binder resin.

Specifically, the hard coating layer may comprise at least one selected from the group consisting of a urethane acrylate-based compound, an acrylic ester-based compound, and an epoxy acrylate-based compound. More specifically, the hard coating layer may comprise a urethane acrylate-based compound and an acrylic ester-based compound.

The urethane acrylate-based compound may comprise a urethane bond as a repeat unit and may have a plurality of functional groups.

The urethane acrylate-based compound may be one in which a terminal of a urethane compound formed by reacting a diisocyanate compound with a polyol is substituted with an acrylate group. For example, the diisocyanate compound may comprise at least one of a linear, branched, or cyclic aliphatic diisocyanate compound having 4 to 12 carbon atoms and an aromatic diisocyanate compound having 6 to 20 carbon atoms. The polyol comprises 2 to 4 hydroxyl (—OH) groups and may be a linear, branched, or cyclic aliphatic polyol compound having 4 to 12 carbon atoms or an aromatic polyol compound having 6 to 20 carbon atoms. The terminal substitution with an acrylate group may be carried out by an acrylate-based compound having a functional group capable of reacting with an isocyanate group (—NCO). For example, an acrylate-based compound having a hydroxyl group or an amine group may be used, and a hydroxyalkyl acrylate or aminoalkyl acrylate having 2 to 10 carbon atoms may be used.

The urethane acrylate-based compound may contain 2 to 15 functional groups.

Examples of the urethane acrylate-based compound include a bifunctional urethane acrylate oligomer having a weight average molecular weight of 1,400 to 25,000, a trifunctional urethane acrylate oligomer having a weight average molecular weight of 1,700 to 16,000, a tetra-functional urethane acrylate oligomer having a weight average molecular weight of 500 to 2,000, a hexa-functional urethane acrylate oligomer having a weight average molecular weight of 818 to 2,600, an ennea-functional urethane acrylate oligomer having a weight average molecular weight of 2,500 to 5,500, a deca-functional urethane acrylate oligomer having a weight average molecular weight of 3,200 to 3,900, and a pentakaideca-functional urethane acrylate oligomer having a weight average molecular weight of 2,300 to 20,000, but it is not limited thereto.

The urethane acrylate-based compound may have a glass transition temperature (Tg) of −80° C. to 100° C., −80° C. to 90° C., −80° C. to 80° C., −80° C. to 70° C., −80° C. to 60° C., −70° C. to 100° C., −70° C. to 90° C., −70° C. to 80° C., −70° C. to 70° C., −70° C. to 60° C., −60° C. to 100° C., −60° C. to 90° C., −60° C. to 80° C., −60° C. to 70° C., −60° C. to 60° C., −50° C. to 100° C., −50° C. to 90° C., −50° C. to 80° C., −50° C. to 70° C., or −50° C. to 60° C.

The acrylic ester-based compound may be at least one selected from the group consisting of a substituted or unsubstituted acrylate and a substituted or unsubstituted methacrylate. The acrylic ester-based compound may contain 1 to 10 functional groups.

Examples of the acrylic ester-based compound include trimethylolpropane triacrylate (TMPTA), trimethylolpropaneethoxy triacrylate (TMPEOTA), glycerin propoxylated triacrylate (GPTA), pentaerythritol tetraacrylate (PETA), and dipentaerythritol hexaacrylate (DPHA), but it is not limited thereto.

The acrylic ester-based compound may have a weight average molecular weight of 500 to 6,000, 500 to 5,000, 500 to 4,000, 1,000 to 6,000, 1,000 to 5,000, 1,000 to 4,000, 1500 to 6,000, 1,500 to 5,000, or 1,500 to 4,000. The acrylic ester-based compound may have an acrylate equivalent of 50 g/eq. to 300 g/eq., 50 g/eq. to 200 g/eq., or 50 g/eq. to 150 g/eq.

The epoxy acrylate-based compound may contain 1 to 10 functional groups. Examples of the epoxy acrylate-based compound include a monofunctional epoxy acrylate oligomer having a weight average molecular weight of 100 to 300, a bifunctional epoxy acrylate oligomer having a weight average molecular weight of 250 to 2,000, and a tetra-functional epoxy acrylate oligomer having a weight average molecular weight of 1,000 to 3,000, but it is not limited thereto. The epoxy acrylate-based compound may have an epoxy equivalent of 50 g/eq. to 300 g/eq., 50 g/eq. to 200 g/eq., or 50 g/eq. to 150 g/eq.

The content of the organic resin may be 30% by weight to 100% by weight based on the total weight of the hard coating layer. Specifically, the content of the organic resin may be 40% by weight to 90% by weight, or 50% by weight to 80% by weight, based on the total weight of the hard coating layer.

The hard coating layer may optionally further comprise a filler. The filler may be, for example, inorganic particles. Examples of the filler include silica, barium sulfate, zinc oxide, and alumina. The filler may have a particle diameter of 1 nm to 100 nm. Specifically, the particle diameter of the filler may be 5 nm to 50 nm or 10 nm to 30 nm. The filler may comprise inorganic fillers having particle size distributions different from each other. For example, the filler may comprise a first inorganic filler having a D50 of 20 nm to 35 nm and a second inorganic filler having a D50 of 40 nm to 130 nm. The content of the filler may be 25% by weight or more, 30% by weight or more, or 35% by weight or more, based on the total weight of the hard coating layer. In addition, the content of the filler may be 50% by weight or less, 45% by weight or less, or 40% by weight or less, based on the total weight of the hard coating layer. Preferably, the hard coating layer may not comprise an inorganic filler such as silica. In such a case, for example, the adhesion between the base film and the hard coating layer of the composition described above may be enhanced.

The hard coating layer may further comprise a photoinitiator. Examples of the photoinitiator include 1-hydroxy-cyclohexyl-phenyl ketone, 2-hydroxy-2-methyl-1-phenyl-1-propanone, 2-hydroxy-1-[4-(2-hydroxyethoxy)phenyl]-2-methyl-1-propanone, methylbenzoylformate, α,α-dimethoxy-α-phenylacetophenone, 2-benzoyl-2-(dimethylamino)-1-[4-(4-morpholinyl)phenyl]-1-butanone, 2-methyl-1-[4-(methylthio)phenyl]-2-(4-morpholinyl)-1-propanone diphenyl(2,4,6-trimethylbenzoyl)-phosphine oxide, and bis(2,4,6-trimethylbenzoyl)-phenylphosphine oxide, but it is not limited thereto. In addition, commercially available products include Irgacure 184, Irgacure 500, Irgacure 651, Irgacure 369, Irgacure 907, Darocur 1173, Darocur MBF, Irgacure 819, Darocur TPO, Irgacure 907, and Esacure KIP 100F. The photoinitiator may be used alone or in combination of two or more different types.

The hard coating layer may further comprise an antifouling agent. For example, the hard coating layer may comprise a fluorine-based compound. The fluorine-based compound may have an antifouling function. Specifically, the fluorine-based compound may be an acrylate-based compound having a perfluorine-based alkyl group. Specific examples thereof may include perfluorohexylethyl acrylate, but it is not limited thereto.

The hard coating layer may further comprise an antistatic agent. The antistatic agent may comprise an ionic surfactant. For example, the ionic surfactant may comprise an ammonium salt or a quaternary alkylammonium salt, and the ammonium salt and the quaternary alkylammonium salt may comprise a halide such as a chloride or a bromide.

In addition, the hard coating layer may further comprise additives such as surfactants, UV absorbers, UV stabilizers, anti-yellowing agents, leveling agents, and dyes to improve color values. For example, the surfactant may be a monofunctional to bifunctional fluorine-based acrylate, a fluorine-based surfactant, or a silicone-based surfactant. The surfactant may be employed in a form dispersed or crosslinked in the hard coating layer. In addition, examples of the UV absorber include benzophenone-based compounds, benzotriazole-based compounds, and triazine-based compounds. Examples of the UV stabilizer include tetramethyl piperidine and the like. The content of the additives may be variously adjusted within a range that does not impair the physical properties of the hard coating layer. For example, the content of the additives may be 0.01 to 10% by weight based on the weight of the hard coating layer, but it is not limited thereto.

The hard coating layer may be composed of a single layer or two or more layers. As an example, the hard coating layer is formed as a single layer and can simultaneously increase the durability of the laminate film and function as anti-fingerprint or anti-contamination.

The hard coating layer may have a thickness of 2 μm or more, 3 μm or more, 5 μm or more, or 10 μm or more, and 50 μm or less, 30 μm or less, 20 μm or less, or 10 μm or less. For example, the thickness of the hard coating layer may be 2 μm to 20 μm. Specifically, the thickness of the hard coating layer may be 5 μm to 20 μm. If the thickness of the hard coating layer is too thin, it may not have sufficient surface hardness to protect the base film, so that the durability of the laminate film may be deteriorated. If it is too thick, the flexibility of the laminate film may be deteriorated, and the overall thickness of the laminate film may be increased, which may be disadvantageous for forming a thin film.

Accordingly, the hard coating layer may be formed from a hard coating composition comprising at least one of an organic-based composition, an inorganic-based composition, and an organic-inorganic composite composition. For example, the hard coating composition may comprise at least one of an acrylate-based compound, a siloxane compound, and a silsesquioxane compound. In addition, the hard coating layer may further comprise inorganic particles. As a specific example, the hard coating layer may be formed from a hard coating composition comprising a urethane acrylate-based compound, an acrylic ester-based compound, and a fluorine-based compound.

The hard coating layer may be formed by applying a hard coating composition on the base film, followed by drying and curing thereof.

The hard coating composition may comprise the organic resin, photoinitiator, antifouling additive, antistatic agent, other additives and/or solvents described above.

Examples of the organic solvent include alcohol-based solvents such as methanol, ethanol, isopropyl alcohol, and butanol; alkoxy alcohol-based solvents such as 2-methoxyethanol, 2-ethoxyethanol, and 1-methoxy-2-propanol; ketone-based solvents such as acetone, methyl ethyl ketone, methyl isobutyl ketone, methyl propyl ketone, and cyclohexanone; ether-based solvents such as propylene glycol monopropyl ether, propylene glycol monomethyl ether, ethylene glycol monoethyl ether, ethylene glycol monopropyl ether, ethylene glycol monobutyl ether, diethylene glycol monomethyl ether, diethyl glycol monoethyl ether, diethylene glycol monopropyl ether, diethylene glycol monobutyl ether, and diethylene glycol-2-ethylhexyl ether; and aromatic solvents such as benzene, toluene, and xylene, which may be used alone or in combination thereof.

The content of the organic solvent is not particularly limited since it may be variously adjusted within a range that does not impair the physical properties of the hard coating composition. The organic solvent may be employed such that the weight ratio of the solids content of the components contained in the coating composition to the organic solvent may be about 30:70 to about 99:1. If the content of the organic solvent is within the above range, the composition may have appropriate flowability and coatability.

The hard coating composition may comprise 10% by weight to 30% by weight of an organic resin, 0.1% by weight to 5% by weight of a photoinitiator, 0.01% by weight to 2% by weight of an antifouling agent, and 0.1% by weight to 10% by weight of an antistatic agent. According to the composition, the mechanical properties and antifouling and antistatic characteristics of the hard coating layer may be enhanced together.

The hard coating composition may be coated on the base film by a bar coating method, a knife coating method, a roll coating method, a blade coating method, a die coating method, a microgravure coating method, a comma coating method, a slot die coating method, a lip coating method, or a solution casting method.

Thereafter, the organic solvent contained in the hard coating composition may be removed through a drying step. The drying step may be carried out at a temperature of 40° C. to 100° C., preferably 40° C. to 80° C., 50° C. to 100° C., or 50° C. to 80° C., for about 1 minute to 20 minutes, preferably 1 minute to 10 minutes or 1 minute to 5 minutes.

Thereafter, the hard coating composition layer may be cured by light and/or heat.

### MODE FOR THE INVENTION

The embodiments described below are provided to help understanding, and the scope of implementation is not limited thereto.

### Preparation of a Primer Composition

### Preparation Example 1

A polyester acrylate resin (bifunctional, Mw: 3,800 to 4,000, Miramer PS2500, Miwon Corporation) and N,N-dimethylacrylamide (CAS 2680 Mar. 7) were mixed at a weight ratio of 100:20. 5 parts by weight of a photoinitiator (I-184, BASF) was added to 100 parts by weight of the mixture. Thereafter, it was diluted with methyl isobutyl ketone (MIBK) as a solvent to a solids content of 3% by weight to obtain a primer composition (A-Primer 20).

### Preparation Example 2

A primer composition (A-Primer 15) was obtained according to the procedure of Preparation Example 1, except that the polyester acrylate resin and dimethyl acrylamide were mixed at a weight ratio of 100:15.

### Comparative Preparation Example 1

A primer composition (F-Primer) was obtained by compounding the composition shown in Table 1 below.

TABLE 1

| | | % by |
|---|---|---|
| | Component | weight |
| Solvent | Propylene glycol n-propyl ether | 66.05 |
| Solvent | Methyl isobutyl ketone | 28.31 |
| Solvent | Xylene | 1.01 |
| Solvent | n-Butyl acetate | 2.63 |
| Binder | Acrylic resin | 1.96 |
| Multivalent | Pentaerythritol | 0.04 |
| aziridine | tris(3-aziridine-1-ylpropionate) | |

Acrylic resin: a copolymer of methyl crotonate/methyl methacrylate/butyl acrylate/octyl methacrylate/2-ethylhexyl methacrylate, Mw: about 50,000, Tg: 85° C.

### Preparation of a Laminate Film

### Example 1

### Step (1) Primer Treatment of a Base Film

The primer composition (A-Primer 20) obtained in Preparation Example 1 was coated onto one side of a transparent polyimide-based film (TPI, SKC) with a thickness of 50 μm, which was dried in an oven at 120° C. for 5 minutes and then UV-cured at a light dose of about 500 mJ to form a primer layer with a thickness of about 100 nm.

### Step (2) Extrusion Lamination

A polyether-block-amide resin (Arkema Pebax™ Rnew™ 72R53, Arkema) was fed to an extruder, extruded at about 240° C., and cast onto the primer layer previously formed on the base film to carry out lamination. For lamination, a pressure of about 5,000 kPa was applied. As a result, a laminate film was obtained in which a PEBA layer with a thickness of 50 μm was formed on the base film through the primer layer.

### Example 2

A laminate film was prepared according to the procedure of Example 1, except that the primer composition (A-Primer 15) obtained in Preparation Example 2 was used to form a primer layer.

### Comparative Example 1

A transparent polyimide-based film with a thickness of 50 μm (TPI, SKC) was laminated with a PEBA film according to the procedure in Step (2) of Example 1, without any primer treatment, to prepare a laminate film.

### Comparative Example 2

A laminate film was prepared according to the procedure of Example 1, except that the primer composition (F-Primer) obtained in Comparative Preparation Example 1 was used to form a primer layer.

The layer configuration of the films prepared above is summarized in Table 2 below.

TABLE 2

| | Layer configuration |
|---|---|
| Ex. 1 | TPI (50 μm)/A-Primer 20 (100 nm)/PEBA 72R53 (50 μm) |
| Ex. 2 | TPI (50 μm)/A-Primer 15 (100 nm)/PEBA 72R53 (50 μm) |
| C. Ex. 1 | TPI (50 μm)/PEBA 72R53 (50 μm) |
| C. Ex. 2 | TPI (50 μm)/F-Primer (100 nm)/PEBA 72R53 (50 μm) |

### Test Example 1: Peel Test (Adhesive Force)

Each laminate film sample was cut to 5 cm in length and 1 cm in width, the interlayer adhesion of which was measured while peeling at 180° in a peel tester. Referring to FIG. 4, the base film side of the laminate film sample (10a) was attached to the peel tester (20), and the PEBA film side was attached to the load cell to peel at an angle (a) of 180° along the longitudinal direction of the sample. As a result, delamination mainly occurred at the interface between the primer layer formed on the base film and the PEBA film (or the interface between the base film and the PEBA film if there was no primer layer). The load (N) applied to the load cell during peeling was measured. The peel test was carried out at an angle of 180°, a speed of 300 mm/minute, and room temperature (about 25° C.).

### Test Example 2: Change in Adhesive Force Over Time

Each laminated film sample was subjected to a peel test in the same manner as in Test Example 1 to measure the initial adhesive force. The final adhesive force was measured after storage at room temperature (about 25° C.) and 50% RH for 96 hours (4 days) or 240 hours (10 days). The adhesive force was measured on five samples. The average of the three values was calculated, excluding the highest and lowest values. The results are shown in Table 3 below.

Change in adhesive force (%)=[(A_{INT}−A_{FIN})/A_{INT}]×100 (A_{INT} is the adhesive force (gf/inch) between the base film and the elastic layer before storage under the above conditions, and A_{FIN} is the adhesive force (gf/inch) between the base film and the elastic layer after storage under the above conditions.)

### Test Example 3: Folding Test

Each laminate film sample was cut to 12 cm in length and 4 cm in width, which was mounted on a folding tester and checked to see whether delamination between layers occurred during repeated folding. The folding test was repeated in-folding (the base film was folded inward) or out-folding (the base film was folded outward) at a radius of curvature of 1.5 R and a folding speed of 1 time/sec. When no interlayer delamination occurred after repeated folding of 200,000 times or more in in-folding, and if no interlayer delamination occurred after repeated folding of 100,000 times or more in out-folding, it was determined as excellent.

The results are shown in Table 3 below.

TABLE 3

| | Peel test (interlayer adhesive force) | | | | | |
|---|---|---|---|---|---|---|
| | | Final adhesive | | Change in adhesive | | |
| | Initial | force (gf/inch) | | force (%) | | |
| | adhesive | After | After | After | After | |
| | force | 96 | 240 | 96 | 240 | Folding |
| | (gf/inch) | hours | hours | hours | hours | test |
| Ex. 1 | 35.4 | 24.5 | 17.4 | 30.8 | 50.8 | Good |
| Ex. 2 | 28.4 | 20.6 | 13.1 | 27.5 | 53.9 | Good |
| C. | 13.5 | 6.8 | 2.1 | 49.6 | 84.4 | Layers |
| Ex. 1 | | | | | | delaminated |
| C. | 2.9 | 0 | 0 | 100 | 100 | Layers |
| Ex. 2 | | | | | | delaminated |

As can be seen from Table 3 above, the laminate films of the Examples in which the lamination configuration and the composition of the primer layer were adjusted had excellent interlayer adhesion and repeated folding durability, indicating that they were suitable for application to the cover window of a foldable display. In contrast, the laminate films of the Comparative Examples had poor interlayer adhesion and lacked repeated folding durability. In addition, the laminate films of the Examples had a smaller change in adhesive force over time than that of the laminated films of the Comparative Examples.

1. A laminate film, which comprises a base film; an elastic layer comprising a polyether-block-amide; and a primer layer interposed between the base film and the elastic layer.

2. The laminate film of claim 1, wherein, when the laminate film is cut to a size of 5 cm in length and 1 cm in width and subjected to a 180° peel test at a speed of 300 mm/min at room temperature, the adhesive force between the base film and the elastic layer is 15 gf/inch or more.

3. The laminate film of claim 1, wherein, when the laminate film is cut to a size of 12 cm in length and 4 cm in width and subjected to repeated folding at room temperature and a folding speed of 1 time/second while the base film is folded inward such that the radius of curvature is 1.5 R, the number of folding until interlayer delamination occurs is 100,000 times or more.

4. The laminate film of claim 1, wherein the primer layer comprises a polyester acrylate with a weight average molecular weight of 1,000 to 7,000.

5. The laminate film of claim 1, wherein the primer layer comprises an acrylamide-based compound.

6. The laminate film of claim 1, wherein the primer layer comprises 100 parts by weight of a polyester acrylate; and 5 parts by weight to 40 parts by weight of an acrylamide-based compound.

7. The laminate film of claim 1, wherein, when the laminate film is stored for 96 hours at room temperature and 50% RH, the change in adhesive force calculated by the following Equation (1) is 35% or less:
$$Change in adhesive force ( \% ) = [ ( {A}_{INT} - {A}_{FIN} ) / {A}_{INT} ] \times 100 \qquad ( 1 )$$
wherein A_{INT} is the adhesive force (gf/inch) between the base film and the elastic layer before storage under the above conditions, A_{FIN} is the adhesive force (gf/inch) between the base film and the elastic layer after storage under the above conditions, and each adhesive force is measured by cutting the laminate film to a size of 5 cm in length and 1 cm in width and subjecting it to a 180° peel test at a speed of 300 mm/minute at room temperature to measure the load applied between the base film and the elastic layer.

8. The laminate film of claim 1, wherein the base film comprises a polymer film or ultra-thin glass (UTG).

9. A process for preparing a laminate film, which comprises:
preparing a primer composition;
applying the primer composition onto a base film and curing it to form a primer layer; and
laminating the base film and an elastic layer through the primer layer to prepare a laminate film,
wherein the elastic layer comprises a polyether-block-amide, and, when the laminate film is cut to a size of 5 cm in length and 1 cm in width and subjected to a 180° peel test at a speed of 300 mm/minute at room temperature, the adhesive force between the base film and the elastic layer is 15 gf/inch or more.

10. The process for preparing a laminate film of claim 9, wherein the primer composition comprises 100 parts by weight of a polyester acrylate; and 5 parts by weight to 40 parts by weight of an acrylamide-based compound.

11. A display device, which comprises a display panel; and a laminate film disposed on the front side of the display panel,
wherein the laminate film comprises a base film; an elastic layer comprising a polyether-block-amide; and a primer layer interposed between the base film and the elastic layer, and,
when the laminate film is cut to a size of 5 cm in length and 1 cm in width and subjected to a 180° peel test at a speed of 300 mm/min at room temperature, the adhesive force between the base film and the elastic layer is 15 gf/inch or more.
